(19) United States
(12) Patent Application Publication
(10) Pub. No.: US 2024/0053966 A1
(43) Pub. Date: Feb. 15, 2024

(54) SYSTEM AND METHOD FOR CONFIGURING AND IMPLEMENTING INTERFACE CONNECTORS ON A SERVER

(71) Applicant: Rakuten Mobile, Inc., Tokyo (JP)

(72) Inventors: Shankar PRAJAPAT, Madhya Pradesh (IN); Pintu SAHU, Madhya Pradesh (IN)

(21) Appl. No.: 17/766,533

(22) PCT Filed: Mar. 18, 2022
(86) PCT No.: PCT/US2022/020925

§ 371 Date: Apr. 5, 2022

(51) Int. Cl. G06F 8/38; H04L 67/02

(52) U.S. Cl. CPC G06F 8/38; H04L 67/02

(57) ABSTRACT

Systems and methods of configuring communications with a server are disclosed. In some embodiments, a graphical user interface (GUI) is presented on a computer device. The GUI is configured to having one or more graphical items for defining a function and a parameter of an interface connector. User input from the GUI is received that defines a function and a parameter for an interface connector. The interface connector is generated to perform the function that uses the parameter in accordance with the user input.

### BACKGROUND

When applications are implemented on user devices, the application connects to a server that implements different services in order to administer request. Often in order to perform the necessary tasks, servers communicate with other servers. Interface connectors are used to facilitate communications between different applications being run by the servers. Interface connectors often handle requests and trigger flows on the servers to perform requested task and return responses.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 is a block diagram of a computer network, in accordance with some embodiments.

FIG. 2 are panels in a GUI for generating a workflow, in accordance with some embodiments.

FIG. 3 illustrates panels of the GUI that is used to configure the http connector in FIG. 2, in accordance with some embodiments.

FIG. 4 illustrates panels of the GUI that is used to configure the http connector in FIG. 2, in accordance with some embodiments.

FIG. 5 illustrates a panel of the GUI that is used to configure the http connector in FIG. 2, in accordance with some embodiments.

FIG. 6 is a call diagram that describes the implementation of a request between the software application of server and the software application of server in FIG. 1, in accordance with some embodiments.

FIG. 7 is a flow diagram that illustrates one method of generating and implementing a workflow that includes an interface connector, in accordance with some embodiments.

### DETAILED DESCRIPTION

The following disclosure provides many different embodiments, or examples, for implementing different features of the provided subject matter. Specific examples of components, values, operations, materials, arrangements, or the like, are described below to simplify the present disclosure. These are, of course, merely examples and are not intended to be limiting. Other components, values, operations, materials, arrangements, or the like, are contemplated. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

(Optional, use when applicable) Further, spatially relative terms, such as “beneath,” “below,” “lower,” “above,” “upper” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

Systems and methods of configuring communications with a server are disclosed. In some embodiments, a graphical user interface (GUI) is provided so that a user selection is made to configure an interface connector, such as an http connector. The interface connector is a software tool that handles request and responses to requests for a server. The interface connector triggers a flow in the server in response to requests where the flows generate an output that in some embodiments is a response to the request. In some embodiments, the GUI allows the interface connector to be programmed with an algorithm with mechanism for tracking request with request and response details.

In some embodiments, the interface connector provides the ability to handle request response and consume responses in sequential request. In some embodiments, the GUI allows for the programming of the interface connector with having technical expertise.

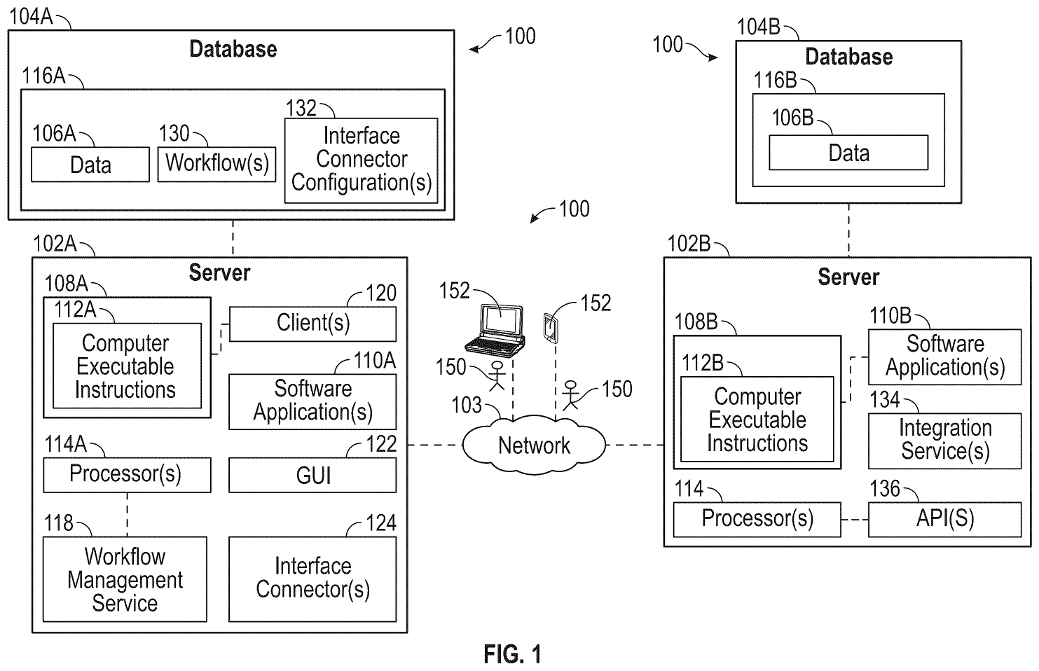

FIG. 1 is a block diagram of a computer network 100, in accordance with some embodiments.

Computer network 100 includes servers 102A, 102B (referred to generically or collectively as server(s) 102) that are operably connected to databases 104A, 104B (referred to generically or collectively as databases 104). Servers 102 are connected to a network 103 and are configured to manage the writing and storing of data 106A, 106B (referred to generically or collectively as 106) stored in non-transitory computer readable media 116A, 116B (referred to collectively or generically as non-transitory computer readable media 116). In some embodiments, the network 103 includes a wide area network (WAN) (i.e., the internet), a wireless WAN (WWAN) (i.e., a cellular network), a local area network (LAN), and/or the like.

More specifically, the server 102A is directly connected (e.g., through a device interface) to database 104A. The database 104A includes non-transitory computer readable media 116A that stores data 106A. Data 106A includes various data items that are written or read by different software applications 110A implemented by the server 102A in order to implement different functionality, as explained in further detail below. Software applications 110A are microservices, web applications, server applications, and an operating system in accordance with some embodiments. Software applications 110A are provided as computer executable instructions 112A that are implemented on one or more processors 114A of the server 102A. The computer executable instructions 112A are stored on non-transitory computer readable medium 108A within the server 102A. In some embodiments, non-transitory computer-readable media 108A, 116A include a random-access memory (RAM), a read-only memory (ROM), an electrically erasable programmable ROM (EEPROM), optical disk storage, magnetic disk storage, other magnetic storage devices, combinations of the aforementioned types of computer-readable mediums, or any other medium that can be used to store computer executable code in the form of instructions or data structures that can be accessed by a computer.

Users devices 152 operated by users 150 communicate with the server 102A through the network 103. Computer executable instructions 112A also cause the processors 114A to implement other software including a workflow management service 118, a client 120, a graphical user interface (GUI) 122, and an interface connector 124. The workflow management service 118 is configured to generate and implement workflow(s) 130 that are implemented by the server 102A. The client 120 is configured to receive certain request to and from the software application(s) 110A and trigger one of the workflows 130, in some embodiments. The interface connector 124 is configured so that external software applications (e.g., software application 1101B in server 102B) to communicate with the software application 110A. More specifically, the interface connector 124 is configured to receive requests either directly from the software application 110A or directly from the client 120. The interface connector 124 is configured to handle requests and responses for the software application 110A on the server 102A, implement functions that trigger flows that are implemented by the software application 110A on the server 102A, provide a response for the software application 110A on the server 102A, and provide parameters related to the flow triggered by the server 102A. In some embodiments, the software application 110A and the external software application (e.g., software application 110B implemented on server 102B) are each microservices. In some embodiments, the interface connector 124 is a hypertext transfer protocol (HTTP) connector and is utilized to handle requests and responses for HTTP based software applications.

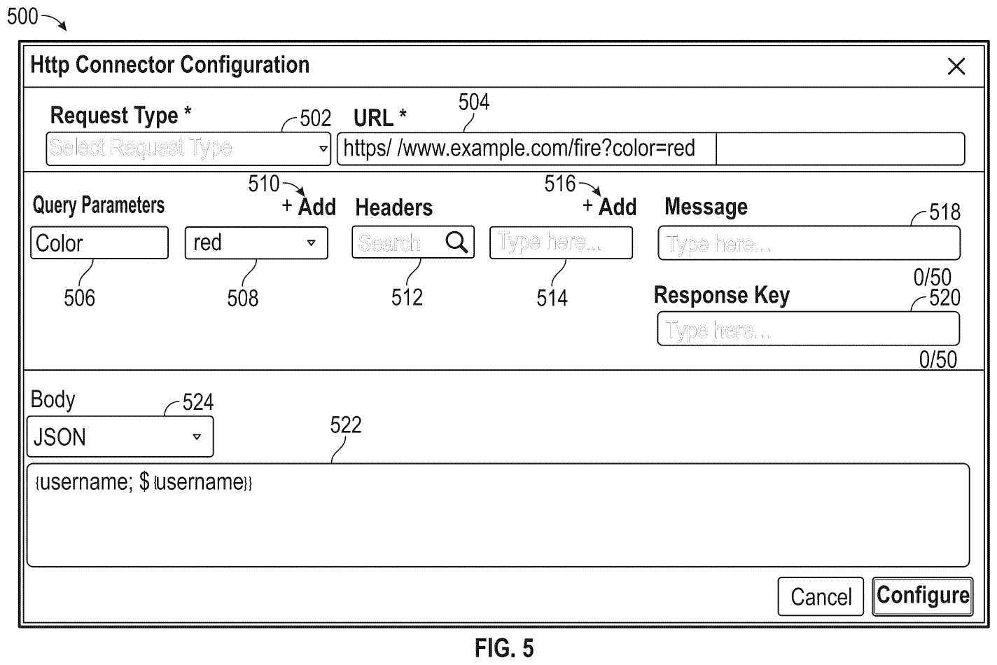

A microservice has an architectural design for building a distributed application using containers. In a microservice, each function of the application operates as an independent service. This architecture allows for each service to scale or update without disrupting other services in the application. The interface connector 124 (e.g., an HTTP connector) has the capability to handle requests and responses from target application 110B (user is configuring in text box 504 in FIG. 5). In some embodiments, the response is reutilized by the software application 110A to decide next possible path in a workflow. In some embodiments, the software application 110A is in a waiting state in order to decide the next procedure to be implemented once a result is received from the software application 110B. In at least one example, the software application 110A is sometimes referred to as the source application and the software application 110B is referred to as the target application. The interface connector 124 is implemented to request data from software application 110B that is to be utilized by software application 110A.

The GUI 122 is configured to present graphical items for interacting with the server 102A. In some embodiments, the GUI 122 presents graphical items that allow for a user 150 through a user device 152 to create workflows 130. Examples of user devices 152 include a cellular phone, a smart phone, a session initiation protocol (SIP) phone, a laptop, a desktop computer, a smart watch, a personal digital assistant (PDA), a satellite radio, a global positioning system, a multimedia device, a video device, a digital audio player (e.g., MP3 player), a camera, a game console, a tablet, a smart device, and a wearable communication device.

Interface connectors 124 are configured through the GUI 122 and triggered during the workflows 130 to allow for different software applications 110A (e.g., microservices) implemented during the workflow 130 to make different request, receive responses, and respond to requests to external software applications (e.g., software application 110B implemented on server 102B, which is an external microservice in accordance with some embodiments). The GUI 122 also allows a user 150 through the user device 152 to configure the interface connectors 124. Configurations for the interface connectors 124 are stored in the database as interface connector configurations 132. Interface connector configurations 132 are called by the server 102A during a workflow 130 to implement different versions of the interface connector 124 depending on the tasks being executed during the workflow 130.

In some embodiments, the interface connector configurations 132 are stored as meta data. In some embodiments, the GUI 122 was developed in Angular JS. In some embodiments, the interface connectors 124 use org.apache.http.client.methods for http communication. In some embodiments, the interface connector 124 operate to have dynamic headers and authorization mechanism. In some embodiments, the interface connector 124 allows for internal communications between microservices to track exceptions and unexpected responses. In some embodiments, the interface connectors 124 implement algorithms, which in some embodiments are written in Java.

The server 102B is directly connected (e.g., through a device interface) to database 104B. The database 104B includes non-transitory computer readable media 116B that stores data 106B. Data 106B includes various data items that are written or read by different software applications 110B implemented by the server 102B in order to implement different functionality, as explained in further detail below. Software applications 1101B are microservices, in accordance with some embodiments. Additionally, the server 102B implements an application-programming interface (API) that is used to interact with the software applications 110B, in accordance with some embodiments. Software applications 110B are microservices, web applications, server applications, and an operating system, in accordance with some embodiments. Software applications 1101B are provided as computer executable instructions 112B that are implemented on one or more processors 114B of the server 102B. The computer executable instructions 112B are stored on non-transitory computer readable medium 108B within the server 102B. In some embodiments, non-transitory computer-readable media 108A, 116A include a random-access memory (RAM), a read-only memory (ROM), an electrically erasable programmable ROM (EEPROM), optical disk storage, magnetic disk storage, other magnetic storage devices, combinations of the aforementioned types of computer-readable mediums, or any other medium that can be used to store computer executable code in the form of instructions or data structures that can be accessed by a computer.

Additionally, when executed by the computer executable instructions 112B are executed by the processor(s) 114B, the processor(s) 114B are further configured to implement integration service(s) 134 and API(s) 136. Both the integration service 134 and the API 136 are configured to process requests and respond to requests for the software applications 110B. In some embodiments, the software applications 1101B are microservices and the integration service 134 and the API 136 are http based software applications. The interface connector(s) 124 is configured to receive and validate the requests from the integration service 134 and/or the API 136 to trigger a flow that is performed by the software application 110A. Once a response is received because of the flow, the interface connector(s) 124 is configured to return the response to the integration service 134 and/or the API 136. The integration service 134 and/or the API 136 then processes and validates the response and returns the response to the software application 110B. In some embodiments, the integration service 134 is the microservice and the API 136 is the interface which is used to communicate between different microservices.

In some embodiments, the interface connector(s) 124 is configured to receive and validate a requests from the software application 110A and/or the client 120 as a result trigger a flow that is performed by the software application 110A. The interface connector 124 is configured to send the request to the integration service 134 and/or the API 136. Once a response is received, the integration service 134 and/or the API 136 validate and process the request and transmit the request to the software application 110B. In response, a flow is triggered by the software application 110B of the server 102B so that the software application 110B generates a response. The software application 110B then provides the response to the integration service 134 and/or the API 136. The integration service 134 and/or the API 136 then transmit the response to the interface connector(s) 124. The interface connector(s) 124 is configured to validate the response and send the response to the software application 110A. In some embodiments, the different types of functions that are requested with the interface connector include GET, POST, PUT, DELETE, and/or the like.

The GUI 122 is generated by the server 102A and is configured to be presented to a user either by the server 102A or by one of the user devices 152. The GUI 122 is configured to generate workflows 130 that include instances of the interface connector(s) 124. By receiving user input through the GUI 122, the GUI 122 communicates with the workflow management service 118 to generate the workflows 130 and generate interface connector configurations 132. The interface connector configurations 132 configure the interface connector(s) 124 so that the interface connector(s) 124 communicates with, processes requests, and processes responses to and from the requests from the integration service 134 and/or the API 136.

In particular, the GUI 122 is configured to present graphical item(s) for defining functions and parameters of the interface connector 124. User input is received through the GUI 122 that define the functions and parameters for the interface connector 124. The workflow management service 118 then generates the interface connector 124 to perform the functions and obtain the parameters defined by the user input. In some embodiments, the workflow management service 118 then generates the interface connector 124 generates the interface connector 124 by generating and storing an interface connector configuration that includes the configuration of the functions and the parameters defined by the user input. The workflow management service 118 then implements an instance of the interface connector 124 by obtaining the particular interface connector configuration 132 during the implementation of the workflow 130.

In some embodiments, the interface connector 124 is an http connector. In some embodiments, the user input is entered into the GUI 122 as a user selection that identifies a function and a Uniform Resource Locator (URL) that identifies parameters and a location to send the request from the server 102A to the integration service 134 of the particular software application 110B (which in some embodiments is a microservice), or to the API 136. The workflow management service 118 obtains the user selection of the functions and extracts the parameters from the URL to generate the particular interface connector configuration 132.

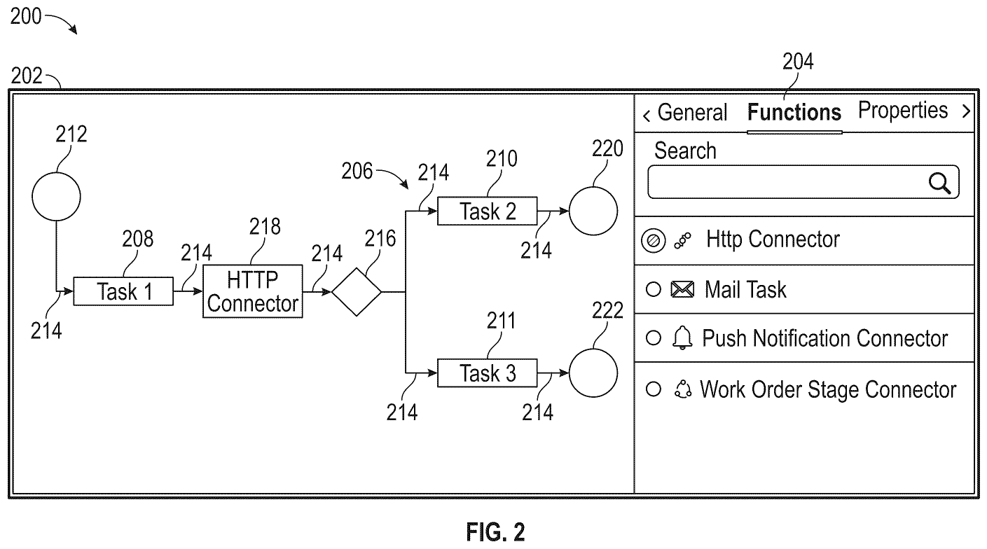

FIG. 2 are panels 202, 204 in a GUI 200 for generating a workflow 206, in accordance with some embodiments.

The GUI 200 is an example of the GUI 122 from FIG. 1, in accordance with some embodiments. The workflow 206 is an example of the workflow 130, in FIG. 1. The workflow management service 118 in FIG. 1 is configured to generate and implement the workflow 206, in accordance with some embodiments.

Panel 202 includes a visual representation of the workflow 206. The workflow 206 includes graphical items 208, 210, 211 that represent assigned tasks, (e.g., tasks1, tasks2, tasks 3). A graphical item 212 indicates the start of the workflow 206 and arrows 214 indicate a sequential order of the workflow. A graphical item 216 indicates that a decision in the workflow 206. Graphical item 218 represents an http connector, which is an example of the interface connector 124 implemented in accordance with an interface connector configuration 132 in FIG. 1. Graphical items 220, 222 represent end points of the workflow 206. In some embodiments, tasks include user tasks (executed by the user 150 through the user devices 152), script tasks (executed by predefined scripts, e.g., Javascript, python), service tasks (automated tasks that execute one or more predefined algorithms, message tasks (waiting state tasks that are completed when a message is received), and/or the like.

The workflow management service 118 initiates the workflow 206 at the start represented by graphical item 212. Next, the workflow management service 118 initiates task 1 and causes task 1 to be implemented by the software application 110A represented by graphical item 208. The software application 110A then transmits the output of task 1 to the http connector represented by the graphical item 218 (also referred to as http connector 218). The workflow management service 118 ensures that the appropriate interface connector configuration 132 is loaded with the http connector represented by graphical item 218. The http connector 218 then makes a request, which includes functions or parameters that can vary.

In some embodiments, the request is logged in a database (e.g., database 104A) when the http connector 218 is to be implemented by the workflow 206. The request is then sent to the integration service 134. When the http connector 218 receives a response from the integration service 134, the response is logged in a database (e.g., database 104A) so that the http connector 218 reads the response.

In some embodiments, the workflow management service 118 creates a work order for an instance of the http connector 218 when the workflow 206 begins execution. The workflow management service 118 is configured to load the interface connector configuration 132. The workflow management service 118 then initiates an instance of the http connector 218 based on the interface connector configuration 132 at the appropriate time during the execution of the workflow 206.

In some embodiments, the request from the http connector 218 results in software application 110B implementing task 2 represented by graphical item 210. The workflow 206 is then ended at the endpoint represented by graphical item 220. In some embodiments, the request from the http connector 218 results in software application 1101B implementing task 3 represented by graphical item 211. The workflow 206 is then ended at the endpoint represented by graphical item 222.

Panel 204 is configured to allow a user (e.g., user 150) to make user selections and create or modify workflows 206. In particular, panel 204 currently illustrates a selection of the http connector 218. The user selection is used to make a selection that an http connector 218 is to be configured.

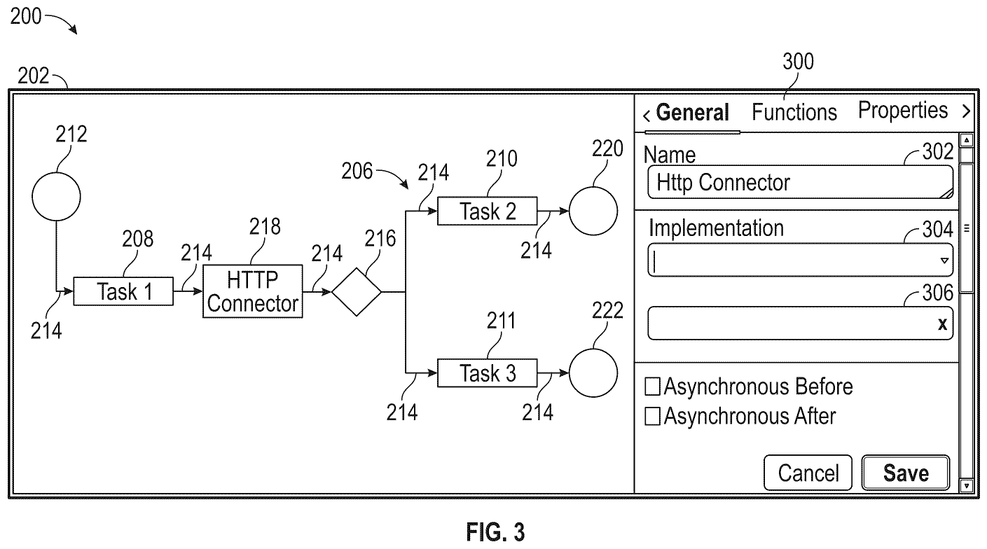

FIG. 3 illustrates panels 202, 300 of the GUI 200 that is used to configure the http connector 218 in FIG. 2, in accordance with some embodiments.

The panel 202 is described above with respect to FIG. 2.

Panel 300 includes a text bar 302 configured to receive text as a user selection. The text is the name of the http connector 218. The panel 300 also includes a selection bar 304 where the type for the http connector 218. For example, the selection bar 304 includes selections for Java, HTML, Scala, Kotlin, Python, Ruby, and/or the like. The selection bar 304 receives a user selection of one of the selections, which indicates the type for the http connector 218. Panel 300 includes a text bar 306 configured to receive text as a user selection. The text indicates a class of the http connector 218, where the class categories depend on the user selection from the selection bar 304 in accordance with some embodiments.

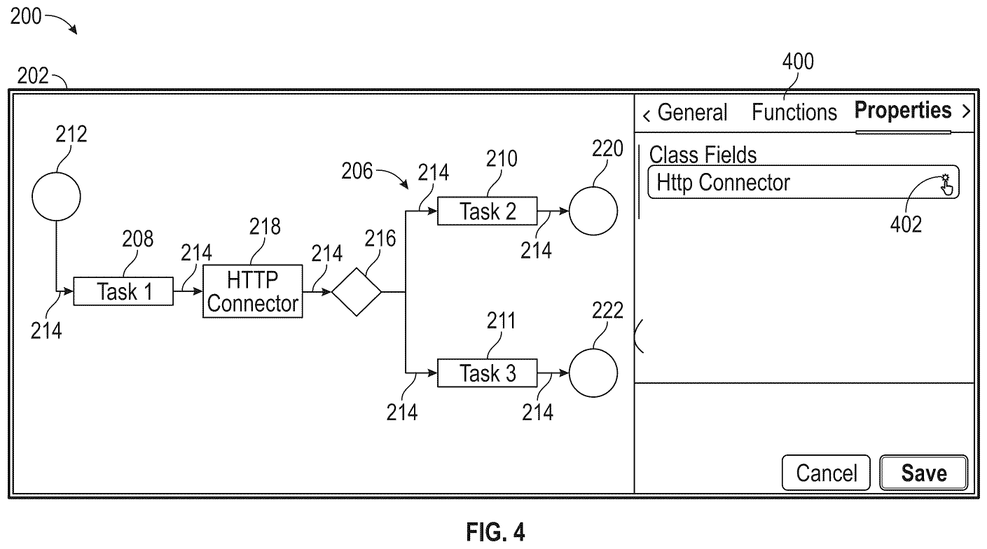

FIG. 4 illustrates panels 202, 400 of the GUI 200 that is used to configure the http connector 218 in FIG. 2, in accordance with some embodiments.

The panel 202 is described above with respect to FIG. 2.

Panel 400 includes a configuration bar 402. The configuration bar 402 is configured to provide class field selections for class fields. A user selection is configured to receive one or more of the class field selections that indicate class fields for the http connector 218.

FIG. 5 illustrates a panel 500 of the GUI 200 that is used to configure the http connector 218 in FIG. 2, in accordance with some embodiments.

The panel 500 includes a selection bar 502. The selection bar 502 includes function selections that indicate a function of the http connector 218. In some embodiments, the different functions selections indicate functions such as GET, POST, PUT, DELETE, and/or the like. In some embodiments, function selections depend on the type of http connector selected.

The panel 500 includes a text bar 504. The text bar 504 is configured to receive a URL that indicates a location to send the request. In some embodiments, the location indicates the location to send the request from the server 102A to the software application 110B (e.g., a microservice) or the API 136. The URL also identifies a parameter (e.g., “color” in FIG. 5) and a value for the parameter (“e.g. red”).

The panel 500 includes a text bar 506 and a selection bar 508. The text bar 506 and the selection bar 508 are used to define a parameter (e.g., “color” in FIG. 5) and a value for the parameter (“e.g. red”). In some embodiments, the URL is input into the text bar 504, the parameter and the value of the parameter are automatically extracted from the URL to populate the text bar 506 and the selection bar 508. In this manner, the parameter(s) for the http connector 218 are defined. In some embodiments, user inputs are received as text in the text bar 506 and as a value selection in selection bar 508 to define parameter(s). A user selection with regards to the add feature 510 is selectable to include more text bars, like the text bar 506, and/or selections bars, like the selection bar 508, so that more parameters are defined.

In some embodiments, assigning the parameter value to a parameter includes selecting one of two values representing result of the comparison, e.g., a first value representing a match within a threshold and a second value representing a match outside the threshold, the text “pass” or “match” for a match within a threshold and the text “fail” or “no match” for a match outside of the threshold.

In some embodiments, assigning the parameter value to a parameter includes selecting one value from a plurality of discrete values, each value representing different state, e.g., a first value representing an exact match, a second value representing a match within a threshold, and a third value representing a match outside the threshold. Another embodiment different text is selectable as the parameter value (e.g., “red,” “green,” “blue,” “orange,” etc.)

In some embodiments, assigning the parameter value to a parameter includes assigning a value from a continuous set of values, e.g., a correlation result having any value ranging from 0 to 1. In this case, the selection bar 508 is converted into a text box to enter in a parameter value for the parameter.

Text box 518 is included in the panel 500 in order to enter in a user message that is included with the http connector 218 in accordance with some embodiments. Text box 520 is provided in the panel in order to receive user text that defines a parameter set to be set to a value related to a response to the request. In some embodiments, the parameter is assigned to receive a response with respect to internal conditions of the software application 110B that receives the request or the API 136 that receives the request. In some embodiments, the parameter is assigned to receive a response with respect to output for the request of the software application 110B or the API 136.

Text box 522 is configured to receive user text for code that defines an algorithm to be implemented by the http connector 218. The text box 522 is also configured to receive user text that defines parameters relevant to the operation of the http connector 218 or to set as inputs and outputs for the request. Selection box 524 includes selections that allow a user to select a language in which the algorithms or parameter assignments are written in. As such, the user selects a syntax for the text box 522 through the selection box 524. Examples of languages include JSON, ASCII, XML, CSV, Java, Python, Ruby, and/or the like.

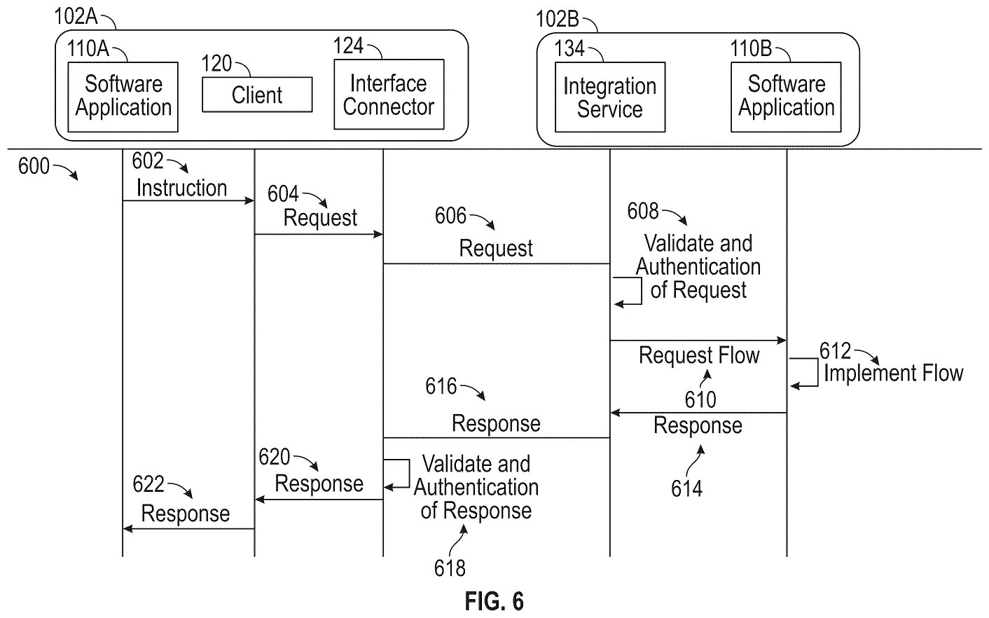

FIG. 6 is a call diagram 600 that describes the implementation of a request between the software application 110A of server 102A and the software application 110B of server 102B in FIG. 1, in accordance with some embodiments.

For the purposes of discussion, the request is presumed to be a request for data. However, this discussion is also applicable to other types of requests, such as read, write, delete operations, and/or the like.

Call diagram 600 includes blocks 602-622, in accordance with some embodiments. Flow begins at block 602.

At block 602, the software application 110A of server 102A sends an instruction to the client 120 to request data to the client 120. At block 604, the client 120 generates a request for the data, which is formatted as input to the interface connector 124 in response to receiving the instruction from the client 120. At block 606, the interface connector 124 is configured to generate another request for the data. The request includes a defined function and one or more defined parameters related to the defined function. The request also includes the relevant headers. The interface connector 124 implements a script in order to obtain the data, in accordance with some embodiments.

The integration service 134 is configured to validate and authenticate the request at block 608. At block 610, the integration service 134 generates a request for a flow to obtain the data from the software application 110B. At block 612, the software application 110B implements the flow and obtains the requested data. At block 614, the software application 110B generates and sends a response with the data to the integration service 134. The integration service 134 then generates another response formatted for communication with the interface connector 124 and sends the response to the interface connector 124, at block 616. The interface connector 124 then validates and authenticates the response at block 618. The interface connector 124 validates and authenticates the response in accordance with the headers of the interface connector 124 and/or in accordance with an algorithm written for validation and authentication, at block 618. At block 620, the interface connector 124 generates a response with the requested data that is formatted in accordance with input requirements for the client 120 and sends the response with the requested data to the client 120, at block 620. At block 622, the client 120 generates another response with the requested data that is formatted in accordance with input requirements for the software application 110A and sends the response with the requested data to the software application 110A, at block 620. In some embodiments, both the software application 110A and the software application 110B are microservices. In some embodiments, the integration service 134 is replaced with the API 136.

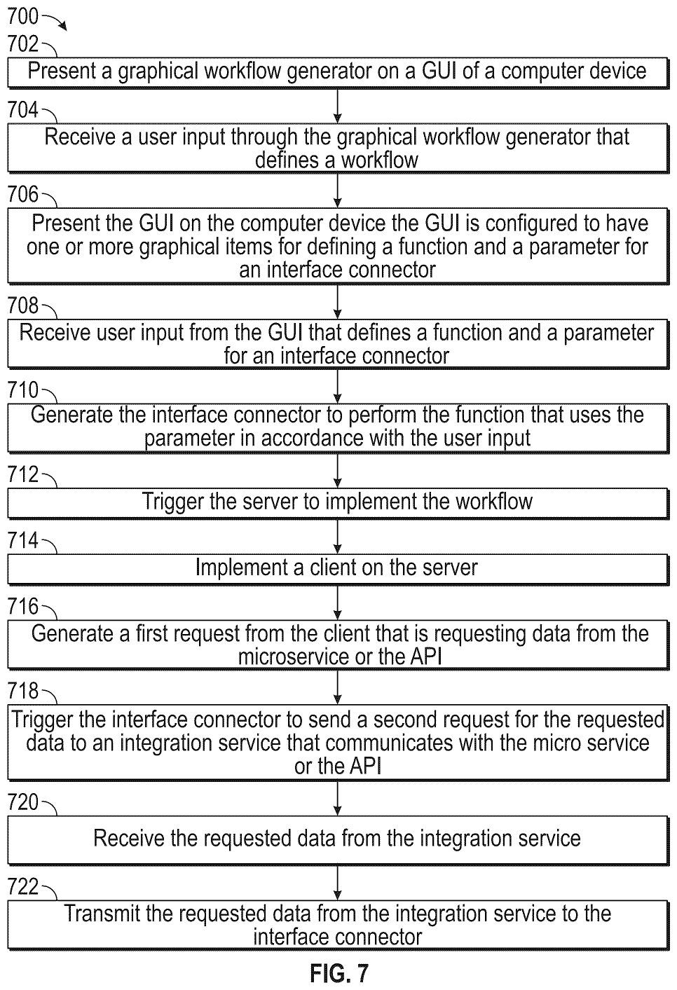

FIG. 7 is a flow diagram 700 that illustrates one method of generating and implementing a workflow that includes an interface connector, in accordance with some embodiments.

Flow diagram 700 is implemented by the computer network 100 shown in FIG. 1, in accordance with some embodiments. Flow diagram 700 includes blocks 702-722. Blocks 702-710 are implemented by the server 102A in order to generate the workflow and the interface connector, in accordance with some embodiments. Examples of the workflow include the workflow(s) 130 in FIG. 1 and examples of the interface connector includes the interface connector(s) 124 in FIG. 1 along with the interface connector configuration(s) 132 in FIG. 1. Blocks 712-722 related to the implementation of the workflow that utilizes the interface connector and is implemented by server 102A and server 102B in FIG. 1, in accordance with some embodiments. Flow begins at block 702.

At block 702, a graphical workflow generator is presented on a GUI of the computer device. Examples of the graphical workflow generator are shown in panel 202 in FIG. 2-4, in accordance with some embodiments. An example of the GUI is the GUI 200 shown in FIGS. 2-5. An example of the computer device is the server 102A in FIG. 1 or the user devices 152 in FIG. 1. Flow then proceeds to block 704.

At block 704, user input is received through the graphical workflow generator that defines a workflow. An example of the user input is the user input that selects and configures graphical items 208-222 in FIG. 2-4. An example of the workflow includes workflow(s) 130 in FIG. 1 and workflow 206 in FIGS. 2-4. Flow then proceeds to block 706.

At block 706, the GUI is presented on the computer device, the GUI is configured to have one or more graphical items for defining a function and a parameter of an interface connector. An example of the graphical items for defining the function and parameter are shown in panel 500 of GUI 200 in FIG. 5. An example of the interface connector is interface connector 124 in FIG. 1 and the http connector 218 shown in FIG. 2-4. Flow then proceeds to block 708.

At block 708, user input from the GUI that defines the function and the parameter for the interface connector. Selection bar 502 in FIG. 5 is used to define the function and items 506, 508 in FIG. 5 define the parameter. In some embodiments, the different types of functions that are selectable through the selection bar 502 include GET, POST, PUT, DELETE functions and/or the like.

Flow then proceeds to block 710.

At block 710, the interface connector is generated to perform the function that uses the parameter in accordance with the user input. In some embodiments, this includes generating interface connector configuration 132 in FIG. 1. Flow then proceeds to block 712.

At block 712, the server is triggered to implement the workflow. An example of the server is server 102A. An example of the workflow is workflow 130 in FIG. 1 and workflow 206 in FIG. 2-4. Flow then proceeds to block 714.

At block 714, a client is implemented the server. An example of the client is the client 120 in FIG. 1. Flow then proceeds to block 716.

At block 716, a first request is generated from the client that is requesting data from the microservice or the API. An example of the microservice is some embodiments of the software application 110B and an example of the API is the API 136 in FIG. 1. Flow then proceeds to block 718.

At block 718, the interface connector is triggered to send a second request for the requested data to an integration service that communicates with the microservice or the API. An example of the integration service is the integration service 134 in FIG. 1. Flow then proceeds to block 722.

At block 722, the requested data is received from the integration service. An example of the requested data is or includes part of the data 106B in FIG. 1. Flow then proceeds to block 724.

At block 724, the requested data is transmitted from the integration service to the interface connector. In some embodiments, this is performed through the client.

In some embodiments, a method of configuring communications with a server, includes: presenting a graphical user interface (GUI) on a computer device, the GUI is configured to having one or more graphical items for defining a function and a parameter of an interface connector; receiving user input from the GUI that defines a function and a parameter for an interface connector; generating the interface connector to perform the function that uses the parameter in accordance with the user input. In some embodiments, the interface connector is a hypertext transfer protocol (HTTP) connector is configured to send request for the server, the function triggers a flow on the server, and the parameter relates to the flow triggered on the server. In some embodiments, the receiving the user input from the GUI that defines the function and the parameter for the interface connector, includes: receiving the user input as: a Uniform Resource Locator (URL) that identifies parameter and a location to send the request from the server to a microservice or an application programming interface (API); and a user selection that identifies the function; and extracting the parameter from the URL. In some embodiments, the generating the interface connector to perform the function that uses the parameter in accordance with the user input includes: implementing the interface connector as an HTTP connector on the server so that the HTTP connector listens for request from the server to the microservice or the API. In some embodiments, the method further includes: implementing a client on the server; generating a first request from the client that is requesting data from the microservice or the API; triggering the HTTP connector to send a second request for the requested data to an integration service that communicates with the microservice or the API; receiving the requested data from the integration service. In some embodiments, the presenting the GUI on the computer device further includes: presenting a graphical workflow generator; receiving second user input through the graphical workflow generator that defines a workflow; wherein the receiving the user input from the GUI that defines the function and the parameter for the interface connector is received through the graphical workflow generator such that the interface connector is part of the workflow. In some embodiments, the method further includes triggering the computer device to implement the workflow.

In some embodiments, an apparatus, includes: a non-transitory computer readable medium that stores computer executable instructions; at least one processor operably associated with the non-transitory computer readable medium, wherein, when the at least one processor executes the computer executable instructions, the at least one processor is configured to: present a graphical user interface (GUI) on a computer device, the GUI is configured to having one or more graphical items for defining a function and a parameter of an interface connector; receive user input from the GUI that defines a function and a parameter for an interface connector; generate the interface connector to perform the function that uses the parameter in accordance with the user input. In some embodiments, the interface connector is a hypertext transfer protocol (HTTP) connector is configured to send request for the server, the function triggers a flow on the server, and the parameter relates to the flow triggered on the server. In some embodiments, the at least one processor is configured to receive the user input from the GUI that defines the function and the parameter for the interface connector by: receiving the user input as: a Uniform Resource Locator (URL) that identifies parameter and a location to send the request from the server to a microservice or an application programming interface (API); and a user selection that identifies the function; and extracting the parameter from the URL. In some embodiments, the at least one processor is configured to generate the interface connector to perform the function that uses the parameter in accordance with the user input by: implementing the interface connector as an HTTP connector on the server so that the HTTP connector listens for request from the server to the microservice or the API. In some embodiments, the at least one processor is further configured to: implement a client on the server; generate a first request from the client that is requesting data from the microservice or the API; trigger the HTTP connector to send a second request for the requested data to an integration service that communicates with the microservice or the API; receive the requested data from the integration service. In some embodiments, the at least one processor is further configured to present the GUI by: presenting a graphical workflow generator; receiving second user input through the graphical workflow generator that defines a workflow; wherein the receiving the user input from the GUI that defines the function and the parameter for the interface connector is received through the graphical workflow generator such that the interface connector is part of the workflow. In some embodiments, the at least one processor is further configured to: trigger the computer device to implement the workflow.

In some embodiments, a non-transitory computer readable medium that stores computer executable instructions, wherein when at least one processor executes the computer executable instructions, the processor is configured to: present a graphical user interface (GUI) on a computer device, the GUI is configured to having one or more graphical items for defining a function and a parameter of an interface connector; receive user input from the GUI that defines a function and a parameter for an interface connector; generate the interface connector to perform the function that uses the parameter in accordance with the user input. In some embodiments, the interface connector is a hypertext transfer protocol (HTTP) connector is configured to send request for the server, the function triggers a flow on the server, and the parameter relates to the flow triggered on the server. In some embodiments, the at least one processor is configured to receive the user input from the GUI that defines the function and the parameter for the interface connector by: receiving the user input as: a Uniform Resource Locator (URL) that identifies parameter and a location to send the request from the server to a microservice or an application programming interface (API); and a user selection that identifies the function; and extracting the parameter from the URL. In some embodiments, the at least one processor is configured to generate the interface connector to perform the function that uses the parameter in accordance with the user input by: implementing the interface connector as an HTTP connector on the server so that the HTTP connector listens for request from the server to the microservice or the API. In some embodiments, the at least one processor is further configured to: implement a client on the server; generate a first request from the client that is requesting data from the microservice or the API; trigger the HTTP connector to send a second request for the requested data to an integration service that communicates with the microservice or the API; receive the requested data from the integration service. In some embodiments, the at least one processor is further configured to present the GUI by: presenting a graphical workflow generator; receiving second user input through the graphical workflow generator that defines a workflow; wherein the receiving the user input from the GUI that defines the function and the parameter for the interface connector is received through the graphical workflow generator such that the interface connector is part of the workflow.

In some embodiments, a non-transitory computer readable medium that stores computer executable instructions, wherein when at least one processor executes the computer executable instructions, the processor is configured to: present a graphical user interface (GUI) on a computer device, the GUI is configured to having one or more graphical items for defining a function and a parameter of an interface connector; receive user input from the GUI that defines a function and a parameter for an interface connector; generate the interface connector to perform the function that uses the parameter in accordance with the user input. In some embodiments, the interface connector is a hypertext transfer protocol (HTTP) connector is configured to send request for the server, the function triggers a flow on the server, and the parameter relates to the flow triggered on the server. In some embodiments, the at least one processor is configured to receive the user input from the GUI that defines the function and the parameter for the interface connector by: receiving the user input as: a Uniform Resource Locator (URL) that identifies parameter and a location to send the request from the server to a microservice or an application programming interface (API); and a user selection that identifies the function; and extracting the parameter from the URL. In some embodiments, the at least one processor is configured to generate the interface connector to perform the function that uses the parameter in accordance with the user input by: implementing the interface connector as an HTTP connector on the server so that the HTTP connector listens for request from the server to the microservice or the API. In some embodiments, the at least one processor is further configured to: implement a client on the server; generate a first request from the client that is requesting data from the microservice or the API; trigger the HTTP connector to send a second request for the requested data to an integration service that communicates with the microservice or the API; receive the requested data from the integration service. In some embodiments, the at least one processor is further configured to present the GUI by: presenting a graphical workflow generator; receiving second user input through the graphical workflow generator that defines a workflow; wherein the receiving the user input from the GUI that defines the function and the parameter for the interface connector is received through the graphical workflow generator such that the interface connector is part of the workflow.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A method of configuring communications with a server, comprising:
presenting a graphical user interface (GUI) on a computer device, the GUI is configured to having one or more graphical items for defining a function and a parameter of an interface connector;
receiving user input from the GUI that defines a function and a parameter for an interface connector;
generating the interface connector to perform the function that uses the parameter in accordance with the user input.

2. The method of claim 1, wherein the interface connector is a hypertext transfer protocol (HTTP) connector is configured to send request for the server, the function triggers a flow on the server, and the parameter relates to the flow triggered on the server.

3. The method of claim 2, wherein the receiving the user input from the GUI that defines the function and the parameter for the interface connector, comprises:
receiving the user input as:
a Uniform Resource Locator (URL) that identifies parameter and a location to send the request from the server to a microservice or an application programming interface (API); and
a user selection that identifies the function; and
extracting the parameter from the URL.

4. The method of claim 3, wherein the generating the interface connector to perform the function that uses the parameter in accordance with the user input comprises:
implementing the interface connector as an HTTP connector on the server so that the HTTP connector listens for request from the server to the microservice or the API.

5. The method of claim 4, further comprising:
implementing a client on the server;
generating a first request from the client that is requesting data from the microservice or the API;
triggering the HTTP connector to send a second request for the requested data to an integration service that communicates with the microservice or the API;
receiving the requested data from the integration service.

6. The method of claim 1, wherein the presenting the GUI on the computer device further comprises:
presenting a graphical workflow generator;
receiving second user input through the graphical workflow generator that defines a workflow;
wherein the receiving the user input from the GUI that defines the function and the parameter for the interface connector is received through the graphical workflow generator such that the interface connector is part of the workflow.

7. The method of claim 6, further comprising
trigerring the computer device to implement the workflow.

8. An apparatus, comprising:
a non-transitory computer readable medium that stores computer executable instructions;
at least one processor operably associated with the non-transitory computer readable medium, wherein, when the at least one processor executes the computer executable instructions, the at least one processor is configured to:
present a graphical user interface (GUI) on a computer device, the GUI is configured to having one or more graphical items for defining a function and a parameter of an interface connector;
receive user input from the GUI that defines a function and a parameter for an interface connector;
generate the interface connector to perform the function that uses the parameter in accordance with the user input.

9. The apparatus of claim 8, wherein the interface connector is a hypertext transfer protocol (HTTP) connector is configured to send request for the server, the function triggers a flow on the server, and the parameter relates to the flow triggered on the server.

10. The apparatus of claim 9, wherein the at least one processor is configured to receive the user input from the GUI that defines the function and the parameter for the interface connector by:
receiving the user input as:
a Uniform Resource Locator (URL) that identifies parameter and a location to send the request from the server to a microservice or an application programming interface (API); and
a user selection that identifies the function; and
extracting the parameter from the URL.

11. The apparatus of claim 10, wherein the at least one processor is configured to generate the interface connector to perform the function that uses the parameter in accordance with the user input by:
implementing the interface connector as an HTTP connector on the server so that the HTTP connector listens for request from the server to the microservice or the API.

12. The apparatus of claim 11, wherein the at least one processor is further configured to:
implement a client on the server;
generate a first request from the client that is requesting data from the microservice or the API;
trigger the HTTP connector to send a second request for the requested data to an integration service that communicates with the microservice or the API;
receive the requested data from the integration service.

13. The apparatus of claim 8, wherein the at least one processor is further configured to present the GUI by:
presenting a graphical workflow generator;
receiving second user input through the graphical workflow generator that defines a workflow;
wherein the receiving the user input from the GUI that defines the function and the parameter for the interface connector is received through the graphical workflow generator such that the interface connector is part of the workflow.

14. The apparatus of claim 13, wherein the at least one processor is further configured to:
trigger the computer device to implement the workflow.

15. A non-transitory computer readable medium that stores computer executable instructions, wherein when at least one processor executes the computer executable instructions, the processor is configured to:
present a graphical user interface (GUI) on a computer device, the GUI is configured to having one or more graphical items for defining a function and a parameter of an interface connector;
receive user input from the GUI that defines a function and a parameter for an interface connector;
generate the interface connector to perform the function that uses the parameter in accordance with the user input.

16. The non-transitory computer readable medium of claim 15, wherein the interface connector is a hypertext transfer protocol (HTTP) connector is configured to send request for the server, the function triggers a flow on the server, and the parameter relates to the flow triggered on the server.

17. The non-transitory computer readable medium of claim 16, wherein the at least one processor is configured to receive the user input from the GUI that defines the function and the parameter for the interface connector by:
receiving the user input as:
a Uniform Resource Locator (URL) that identifies parameter and a location to send the request from the server to a microservice or an application programming interface (API); and
a user selection that identifies the function; and
extracting the parameter from the URL.

18. The non-transitory computer readable medium of claim 17, wherein the at least one processor is configured to generate the interface connector to perform the function that uses the parameter in accordance with the user input by:
implementing the interface connector as an HTTP connector on the server so that the HTTP connector listens for request from the server to the microservice or the API.

19. The non-transitory computer readable medium of claim 18, wherein the at least one processor is further configured to:
implement a client on the server;
generate a first request from the client that is requesting data from the microservice or the API;
trigger the HTTP connector to send a second request for the requested data to an integration service that communicates with the microservice or the API;
receive the requested data from the integration service.

20. The non-transitory computer readable medium of claim 15, wherein the at least one processor is further configured to present the GUI by:
presenting a graphical workflow generator;
receiving second user input through the graphical workflow generator that defines a workflow;
wherein the receiving the user input from the GUI that defines the function and the parameter for the interface connector is received through the graphical workflow generator such that the interface connector is part of the workflow.
